(19) United States
(12) Patent Application Publication
(10) Pub. No.: US 2009/0155736 A1
(43) Pub. Date: Jun. 18, 2009

(54) Method for producing dental moldings

(76) Inventors: Franz Vekoerrer, Huenenberg (CH); Ernst Fleischmann, Gei (AT)

Correspondence Address: FLYNN THIEL BOUTELL & TANIS, P.C., 2026 RAMBLING ROAD, KALAMAZOO, MI, 49008-1631, US

(21) Appl. No.: 11/918,562

(22) PCT Filed: Apr. 12, 2006
(86) PCT No.: PCT/EP2006/003391

§ 371 Date: Nov. 14, 2008

(30) Foreign Application Priority Data
Apr. 12, 2005 (DE) 10 2005 016 939.2

(51) Int. Cl. A61C 13/20; A61C 13/34

(52) U.S. Cl. 433/34; 433/215; 433/202.1

(57) ABSTRACT

In order to produce dental molded parts for a dental prosthesis, a shaping model of the desired dental molded part is made, for example, from wax. The model is embedded in a heat-resistant molding compound. The molding compound is subsequently hardened, and the wax model is melted in order to form a mold cavity that corresponds to the negative of the desired dental molded part. The thermoplastic heated to the processing temperature is introduced with pressure into the formed mold cavity in the molding compound, and the thermoplastic, which forms the desired dental molded part, is removed from the mold once the molding compound is solidified. The molding compound has a temperature of at least 150° C. at the point in time at which the thermoplastic is introduced.

The present invention relates to a method for producing dental moldings according to the preamble of claim 1.

Methods for producing dental prostheses by injection molding or the injection method are known in dental engineering.

Such a method is described in German laid-open application no. 1779542. It is proposed therein, for attaining uniform filling of the mold cavity of a cuvette and for improving the properties of the finished dental prosthesis by avoiding swirls in the structure of the finished dental prosthesis, to liquefy a thermoplastic located in a cartridge and to inject it at high pressure and very fast (fractions of a second) into the mold cavity of a cuvette tempered to approx. 50 degrees centigrade. This very fast injection causes the mold cavity to be filled better, but with complex shapes and long flow paths there repeatedly arises the disadvantage of insufficiently filled places. Further, it has turned out that the strength and dimensional accuracy of thus produced dental prosthesis parts is very poor, so that long-lasting and high-quality dental prostheses cannot be produced with these techniques.

A further method is known from EP 0 917 860 B 1. This involves producing a framework as a dental molding which is anchorable on a remaining tooth and to which at least one replacement tooth is fastened. The aromatic thermoplastic used is polyetheretherketone (PEEK). Although PEEK is a plastic with excellent mechanical properties, the strength of the dental prosthesis produced by the known method is very disappointing. Moreover, the known method cannot be used to process thermoplastics with reinforcing fibers.

Further, it is known to produce dental moldings from pressable ceramics in dental engineering using a molding compound in a muffle having a base member with a projection which corresponds to the negative of a prepressing space into which the plunger is introduced for pressing the ceramic composition into the mold cavity (DE 101 36 584 A1). Since ceramics tend to show crack fracture, such methods only permit the production of individual crowns and at most three-unit bridges for restricted regions (anterior tooth region with little load). Further, the crown copings as well as the bridge anchor copings must be executed with minimum wall thicknesses of no less than 1.5 mm due to the occurring masticatory forces in connection with the crack fracture susceptibility of pressable ceramics. This has the consequence that e.g. in the case of a crown the remaining natural tooth must be ground down to a certain preparation height, which can in some cases cause a traumatism and sensitization of the dental nerve. The greater the wall thicknesses of the dental molding in the area of the tooth stump, the more the dentist must grind the natural tooth and remove tooth substance and the above-mentioned disadvantages occur. There is a desire in dentistry for a metal-free dental prosthesis with high strengths which permits the minimally invasive preparation of tooth stumps.

It is the problem of the invention to provide a dental prosthesis that can be produced by a simple method and that possesses high strength and dimensional accuracy through its isotropic properties even with slight framework design.

This is obtained according to the invention by the method characterized in claim 1. The subclaims render preferred embodiments of the invention. Moreover, a preferred apparatus for carrying out the inventive method is claimed, as well as a preferred blank and a preferred dental molding.

According to the inventive method, the molding compound has a temperature of at least 150° C., preferably at least 200° C., in particular more than 250° C., at least in the area of the mold cavity at the time of introduction of the thermoplastic into the mold cavity. This strong heating of the molding compound causes an improvement in the mechanical properties as well as a reduction of internal stresses and shrinkages as well as warpage, thereby leading to better dimensional stability and dimensional accuracy along with improved mechanical properties of the dental molding. Above all, the mechanical properties are stabilized in all directions, so that an isotropic behavior arises in the dental molding which has the same mechanical properties in all directions. This is very important in the oral region due to the occurrence of cyclic forces upon masticatory loads, since the intrinsic mobility of the teeth also causes very strong torsional loads in the dental moldings.

Studies have shown that in prior art methods when a thermoplastic heated to processing temperature is introduced into the mold cavity of cold or moderately warm molding compounds there occurs a freezing of the thermoplastic molecules oriented by the pressing process in connection with the flow direction. Directly upon contact of the heated thermoplastic with the colder wall inside the molding compound (sprue, mold cavity) there occurs a solidification of the surface area of the dental molding. Inside the thermoplastic the areas still at processing temperature are pressed further into the mold cavity by the pressure, so that different temperature areas and also different morphological structures or layers develop within the cross section of the dental molding. The mechanical properties are thereby very strongly reduced, the result is a dental molding with anisotropic properties and low torsional load capacity. Further, this causes very strong internal stresses which considerably reduce the mechanical properties, on the one hand, and lead to warpage of the dental molding, thus having an adverse effect on dimensional accuracy and dimensional stability, on the other hand.

Particularly in semi-crystalline thermoplastics, this fast solidification very strongly hinders crystallization of the thermoplastic, so that only a reduced degree of crystallization is obtained. The reduced degree of crystallization in turn reduces the density and thus also the mechanical properties of the dental molding. Further, this causes in semi-crystalline thermoplastics strong size differences as well as an inhomogeneous distribution of the spherulites. This reduced degree of crystallization as well as the inhomogeneities and size differences in the spherulites cause strong internal stresses and shrinkages, the result being that the mechanical properties as well as the dimensional accuracy (warpage) are impaired.

Further, it has been ascertained in prior art methods that after completion of production of the dental molding there occur after-crystallization processes which can sometimes last weeks or months. Especially thermoplastics having their Tg below 100 degrees centigrade, specifically with a Tg below 50 degrees centigrade, such as the thermoplastic POM, tend to show strong after-crystallization. Upon said after-crystallization there also occur after-shrinkages and further internal stresses which in turn adversely affect the dimensional accuracy subsequently. This is also a reason why thus produced dental moldings that have been coated with further plastics or otherwise veneered (esthetic veneer of light curing materials) can show bonding problems and in particular an unexpected detachment of the veneer layer due to dimensional changes and warpage.

These disadvantages relate both to amorphous thermoplastics but in particular to semi-crystalline thermoplastics.

Production of the dental molding by the inventive method strongly reduces all these above-mentioned disadvantages in dependence on the difference between the processing temperature and the temperature of the molding compound, and completely avoids them if the molding compound temperature matches the processing temperature, in particular in semi-crystalline thermoplastics. This leads to a homogeneous and uniform distribution and formation of spherulites in the same size, so that the density is increased and internal stresses and shrinkages as well as warpage are avoided. This also avoids after-crystallization since the thermoplastic can already crystallize out ideally upon introduction and upon cooling.

The inventive heating of the molding compound in the area of the mold cavity avoids undesirable freezing and solidification of the thermoplastic and in this connection a molecular orientation.

In fiber reinforced thermoplastics, an orientation of the reinforcing fibers is avoided, in addition to the above-mentioned disadvantages, so that the dental molding has isotropic mechanical properties and dimensional stability in all directions when produced according to the invention.

The inventive production of thermoplastic dental moldings results in a uniform formation of the morphological structure, causing the dental molding to have excellent mechanical properties, in particular very high fracture strength, required primarily in cyclic sustained loading as with dental moldings.

Further, the inventive method increases the density of the dental molding and thus the hardness thereof. Toughness is also improved, and shrinkages are avoided, so that a high improved dimensional accuracy of the dental molding is given.

Also, the high temperature of the molding compound in the area of the mold cavity according to the invention obtains a uniform temperature distribution in all areas of the dental molding, thereby preventing internal cooling and orientation stresses in the dental molding that can lead to a reduction of mechanical strength and to warpage of the dental molding.

The orientations of the molecules on the outer surfaces are dependent not only on the temperature of the molding compound but also on the introduction speed and the shear forces connected therewith. For this reason the heated thermoplastic is preferably introduced slowly into the mold cavity.

The inventive method avoids not only internal molecular stresses but also internal cooling stresses.

It is obvious that if there is a connecting element present in the molding compound that connects the mold cavity to the outer side of the molding compound, or if a prepressing space is present, these areas are also heated to approximately the same temperature as the mold cavity for optimal functioning.

The inventively high temperature of the wall of the mold cavity prevents an orientation of the molecules of the thermoplastic in the flow direction, thereby ensuring high torsional strength of the dental molding.

Thus, the inventive dental molding also withstands the high torsional forces occurring in a great variety of directions during chewing which are caused by the suspension apparatus of the natural tooth (Sharpey's fibers). The high torsional strength due to the isotropic properties of the dental molding is of benefit to any inventive dental prosthesis, i.e. not only fixed dental prostheses such as crowns, bridges, implant abutments, etc., but also removable dental prostheses.

The inventive method can be used to form in particular all dental moldings that are currently produced from metal by the model casting technique, for example palatal plates or palatal bars, in particular clasps for attachment to remaining teeth. Quite generally, the inventive method is suitable in particular for producing removable dental prostheses for upper or lower jaw. It can also be used for producing reinforcing elements in particular for complete dentures, such as base plates.

In particular, the inventive method can be used to produce crowns, bridges and implant abutments as well as parts for attachment technology with gracile designs and high strengths. A further advantage is the use of the dental moldings produced by the inventive method for long-lasting, permanent fixed dental prostheses such as crowns, bridges, implant abutments. Thermoplastics hitherto had only temporary possibilities of use in such applications due to their above-mentioned poor strength values leading to fracture of the dental moldings under cyclic load.

The molding compound preferably has according to the inventive method a temperature in the area of the mold cavity that is no more than 100° C. below the processing temperature of the thermoplastic when the thermoplastic heated to processing temperature is being introduced into the mold cavity in the molding compound. In particular, the molding compound has a temperature in the area of the mold cavity that is no more than 50° C., preferably no more than 15° C., below the processing temperature of the thermoplastic at the time of introduction of the thermoplastic. The processing temperature of the thermoplastic is that temperature at which the thermoplastic is introduced into the mold cavity in the molding compound under pressure.

With amorphous thermoplastics the processing temperature is above the glass transition temperature (Tg) and with semi-crystalline thermoplastics it is above the melting temperature.

In the processing of semi-crystalline thermoplastics the molding compound is preferably heated to a temperature that corresponds to the melting point of the unfilled thermoplastic, or is thereabove.

With aromatic thermoplastics the processing temperature is normally above 300° C., in particular above 330° C.

The processing temperature increases when the thermoplastic is reinforced by reinforcing fibers or the like. Thus, the processing temperature of unreinforced polyaryletherketones is approx. 330 degrees centigrade to 400 degrees centigrade depending on the ether to keto group ratio, and with reinforced or otherwise filled polyaryletherketones it is approx. 360 degrees centigrade to 450 degrees centigrade.

The inventive dental molding can form in particular an inlay, an onlay, a crown, a bridge, a root pin, a post abutment, attachment parts with male and/or female part, or an implant abutment. The inventive dental molding can also form only those framework parts that are veneered with further plastics. The inventive dental molding can also have artificial teeth applied thereto. Further, the dental molding can form parts of removable dental prostheses, primarily load-bearing parts or fastening clasps.

The inventively produced dental molding is normally veneered for esthetic reasons, for example with light curing plastics known in the prior art, which can be appropriately colored.

The inventive method permits dental moldings, for example a crown, to be configured to be particularly thin without losing the high strength. Due to the strongly heated molding compound, the thermoplastic can be pressed even into very thin cavities without morphological inhomogeneities or internal stresses occurring in the dental molding which would reduce its mechanical properties or cause warpage.

This applies preferably also to thermoplastics containing reinforcing fibers and similar fillers. It is thus possible according to the invention to realize a dental prosthesis with minimal invasiveness.

Apart from reinforcing fibers, the thermoplastic can be reinforced e.g. with whiskers or functional fillers, such as hollow glass microspheres.

The inventive method is thus in particular suitable for producing thin-wall moldings with reinforcing fibers. This permits for example the tapered ends in crown copings to be configured to be extremely thin. However, this also applies to palatal plates, fastening clasps in removable dental prostheses or other dental moldings with thin-wall portions.

The shaping model of the inventive dental molding is preferably produced by a generative manufacturing method (rapid prototyping). Such methods permit the shaping models to be manufactured on the basis of computer-internal data models without any elaborate production of dental impressions or tooth models. Previously the dentist scans the oral situation of the teeth and the shaping models are produced from residue-free removable material on the basis of these data, which can optionally be adjusted on the computer to the material being used, by generative techniques, such as stereolithography (STL or SLA), selective laser sintering (SLS), laser generation, fused deposition modeling (FDM), laminated object modeling (LOM), 3D printing, contour crafting (CC) and multi jet modeling.

The thermoplastic used for producing the dental molding according to the invention is preferably an aromatic thermoplastic, in particular an aromatic thermoplastic with aryl groups in the main chain. Suitable aromatic thermoplastics with aryl groups in the main chain are in particular high temperature thermoplastics, such as polyarylates, polyarylene sulfides, polysulfones, liquid crystal polymers, in particular liquid crystal polyesters, polyimides, polyetherimides, polyamidimides or polyaryletherketones, as well as copolymers of at least two of the above-mentioned polymers or a blend of at least two of the above-mentioned aromatic thermoplastics.

It is particularly preferable here to use polyaryletherketones (PAEK) such as polyetherketone (PEK), polyetheretherketone (PEEK), polyetherketoneketone (PEKK), polyetheretherketoneketone (PEEKK) or polyetherketoneetherketoneketone (PEKEKK) or similar bonds of ether and keto units, further copolymers of at least two of said polyaryletherketones or a blend of at least two of said polyaryletherketones.

It is particularly preferable to use polyaryletherketones that have an ether and keto group ratio of about 1:1 (e.g. PEEKK) or in which more keto groups are present than ether group (e.g. PEKK). Such polyaryletherketones have a higher Tg and thus higher strength, but due to the higher Tg also a higher processing temperature and smaller processing windows. In this case as well, high-strength dental moldings can be avoided [sic] with the inventive method while avoiding the known disadvantages.

Quite generally, the inventive method can be used to produce dental moldings from thermoplastics that cannot be processed readily or at all in otherwise usual injection molding apparatuses, such as self-reinforced thermoplastics intended for extrusion processes which are particularly rigid due to the aromatic chain structure (so-called rigid rod polymers).

Polyaryletherketones are characterized by excellent alternating load resistance, creeping strength, form stability and temperature resistance. The inventive method moreover gives them good processibility. Also, said thermoplastics do not tend to show thermal oxidation even at the high processing temperatures, so that no gases can arise that would damage the processing apparatuses. A further advantage of said polyaryletherketones is their low moisture absorption capacity which is important particularly for the oral region.

According to the invention it is preferable to use a thermoplastic containing fillers. Fillers are understood in connection with this invention to be any additive to the thermoplastic. In particular, they are fillers such as color additives or reinforcing fibers or any functional fillers influencing the processibility or the mechanical or thermal properties.

Thus the thermoplastic can contain fillers of altogether more than 10 wt %, preferably more than 30 wt %, according to the invention. Also, the content of reinforcing fibers can be at least 25 wt %, in particular at least 30 wt %. However, considerably higher contents are also possible, for example the content of reinforcing fibers can also be more than 70 wt %, in particular 90 wt % and more.

A special advantage is that the inventive method makes it possible to process thermoplastics that are filled with reinforcing fibers with a diameter of 3 microns to 15 microns and the volume of the fiber content is more than 30 vol %, preferably more than 40 vol %, particularly preferably more than 50 vol %.

A further special advantage in the production of fiber reinforced dental moldings by the inventive method is the strong reduction of fiber damage. Upon heating of the molding compound to the processing temperature of the thermoplastic, in the case of semi-crystalline thermoplastics to above the melting temperature of the thermoplastic, fiber damage and fiber shortening are avoided completely, so that the fibers have the same length in the dental molding as in the blank used.

Filling the thermoplastic with reinforcing fibers involves, besides the reinforcement effect, also the advantage of reduced shrinkage and better dimensional stability and dimensional accuracy as well as further reduced moisture absorption. These advantages are very important for accurately fitting dental moldings in the oral region.

Possible reinforcing fibers are all known organic and inorganic fibrous materials such as synthetic fibers, glass fibers, carbon fibers, etc. It is preferred to use fibers with a fiber diameter between 3 microns and 25 microns, particularly preferably with a fiber diameter of 5 microns to 13 microns.

A further preferred embodiment is to use nanofibers in the thermoplastic.

Filling the mold cavity in the molding compound with the thermoplastic is effected according to the invention at low speed, preferably within a period of time of more than 1 second, preferably more than 3 seconds, in particular more than 6 seconds. This prevents, in interaction with the high molding compound temperature, an orientation of the molecules in the flow direction or, if reinforcing fibers are present, their orientation with the above-mentioned disadvantages. Further, this avoids shearing loads within the thermoplastic melt, which can lead to molecular chain breakage and thus to a reduction of the mechanical properties. Further, this avoidance of shear forces avoids a negative impairment of the fillers, in particular fiber damage.

With temperature-sensitive thermoplastics which tend in particular to show thermal oxidation and thus degradation of mechanical properties, it has proved to be advantageous to carry out the introduction of the thermoplastic into the mold cavity in the heated molding compound in a vacuum or in an atmosphere of inert gas, for example nitrogen or argon.

It has also proved to be advantageous to carry out the cooling of the thermoplastic dental molding in the molding compound under pressure after introduction of the thermoplastic into the mold cavity.

For this purpose, a more or less great pressure can be maintained by the plunger with which the thermoplastic has been introduced into the mold cavity. This obtains high shape accuracy without any shrinkage occurring.

The thermoplastic dental molding in the molding compound is preferably cooled in accelerated fashion, for example by being placed in a cooling apparatus, a fan or by purging with air or an inert gas. The cooling of the thermoplastic dental molding within the molding compound is preferably carried out at a speed of less than 20° C./min, in particular less than 10° C./min, particularly preferably less than 5 degrees C./min.

It has also proved to be advantageous to use a predried thermoplastic for the inventive method. Predrying removes the residual moisture which would lead to bubbles, streaks or the like in the dental molding. Predrying is preferably effected at a temperature of over 130° C. preferably for several hours, for example with PEEK at about 150° C. for at least 3 hours.

The predried thermoplastic is made available for processing preferably in vacuum packed form. This makes it unnecessary to predry the thermoplastic before processing in the dental laboratory.

Further, it has proved to be advantageous to use a thermoplastic in the form of a prefabricated blank or pellet. The blank preferably has a volume corresponding substantially to the dental molding to be produced. That is, the dental technician can thus for example use for a certain dental molding, such as a crown coping, a blank intended therefor of corresponding size. It must be taken into account that polyaryletherketones and the other aromatic thermoplastics with aryl groups in the main chain preferably used according to the invention are in some cases quite costly plastics, so that this avoids excessive loss of material. That is, the prefabricated blank preferably has a volume corresponding to the volume of the mold cavity plus the optionally present connecting channels for connecting the mold cavity to the outer side of the molding compound as well as plus a safety margin of for example at most 25 vol %.

The blank has the advantage that the thermoplastic is present in homogeneously plasticized form, does not have any inclusions of air and, if fillers and reinforcing fibers are used, they are already dispersed homogeneously in the thermoplastic matrix. Moreover, one manages with a compressed blank or preform with a smaller prepressing space.

The blank can have any desired form, being configured for example to be cylindrical, prism-shaped, annular or hollow cylindrical. The blank can be formed for example by extrusion, injection molding, transfer molding or compression molding.

The prefabricated blank can be configured for example to be annular or disk-shaped, i.e. have a greater width than height. However, it is preferable to use a blank having a greater height than width. This permits a higher pressure to be produced with the same force of the pressing plunger, since the area acted on by the plunger is smaller in proportion to the force.

It is preferable to produce a molding compound provided with a prepressing space for receiving the thermoplastic. This permits easy introduction of the thermoplastic by application of pressure into the mold cavity.

The introduction of the thermoplastic into the mold cavity can be effected in any desired way, for example by extrusion, injection and the like. However, it is preferable to use a pressing method. This can be done using a pressing plunger or another plunger-shaped element. The prepressing space is the space into which the blank is put and into which the plunger is introduced. The blank can be heated before introduction into the prepressing space and then heated further in the prepressing space by the hot molding compound. To form the prepressing space it is possible to embed a shaper made of wax, plastic or a similar fusible, combustible or otherwise residue-free removable material into the molding compound and remove it residue-free after the molding compound has cured. However, the shaper for the prepressing space can also be connected to a muffle base and be removed after the molding compound has cured. The shaper for the prepressing space and the muffle base can form a unit made of the same material.

The blank can be introduced into the prepressing space in a cold or a preheated state, but it is preferably preheated to at least 150° C., in particular to just below the processing temperature, and then heated to processing temperature by the molding compound.

The pressing plunger is likewise preferably preheated before introduction of the thermoplastic to at least 150° C. and preferably to just below the processing temperature.

In order for the prepressing space to be sealed by the plunger, the plunger preferably has the same thermal expansion coefficient as the molding compound. The plunger therefore preferably likewise consists of the molding compound at least in the front area.

It has proved to be advantageous to preheat the blank in a sheath, e.g. in an oven, independently of the molding compound. The inside diameter of the sheath, which can consist for example of metal, ceramics or molding compound, corresponds substantially to the outside diameter of the pressing plunger. The sheath can have a bottom. The bottom is then provided with a passage for introducing the thermoplastic into the mold cavity. If the molding compound has a prepressing space, the outside diameter of the sheath corresponds substantially to the diameter of the prepressing space. However, such a sheath can in any case also be attached outside the molding compound fitting the molding compound.

If the molding compound and optionally the pressing plunger have also previously been heated to the inventive temperature of at least 150° C. for example in an oven, an additional heating of the molding compound can thus optionally be completely omitted in the pressing process. It is thus possible to use a very simply constructed apparatus for applying pressure to the blank and/or for applying pressure during cooling of the dental molding (removal). Thus e.g. only a guided weight or a spring can load the pressing plunger to press the thermoplastic into the mold cavity of the molding compound and/or to maintain the post-pressure.

Preferably, the molding compound is heated above the processing temperature of the thermoplastic in an oven. Subsequently a preheated but not yet flowable blank is inserted into the prepressing space and subjected to pressure by a plunger. Due to the insulating properties of the molding compound, the stored heat is released to the thermoplastic and the latter brought to the processing temperature, so that after flowability is reached a simple introduction of the thermoplastic is possible without any further external supply of heat by elaborate constructions.

The molding compound used can be for example the gypsums usual in dental technology, as well as the usual gypsum-bound or phosphate-bound investment compounds. It is fundamentally possible to use any compound as a molding compound that can be positioned around the shaping model in a liquid state and cured, and that has the properties necessary for removing the shaping model (e.g. thermal stability upon removal by temperature or chemical stability upon chemical removal) as well as the thermal stability and compressive strength necessary for introduction of the thermoplastic into the mold cavity as well as the required dimensional accuracy, in particular with regard to the interaction of the expansion and contraction properties between thermoplastic and molding compound.

In particular, molding compounds are preferred that need not be heated beyond the processing temperature of the thermoplastic to reach the strength necessary for the pressing process, primarily air-permeable molding compounds, so that the enclosed air in the mold cavity can escape. It is quite particularly preferable to use molding compounds having a final temperature of approx. 400 degrees centigrade to 450 degrees centigrade, since they then already possess their final hardness and need not be heated any higher (for example phosphate-bound investment compounds with heating temperatures of approx. 600 degrees centigrade to 700 degrees centigrade). This gains time, since one need not wait for the cooling phase and no microcracks arise in the molding compound during cooling, which can lead to poor modeling or to unexpected fractures of the molding compound during pressing.

Therefore, gypsum-bound molding compounds are preferred.

The inventive method causes the introduction of the thermoplastic into the mold cavity of the molding compound to be controlled primarily by the temperature of the investment compound. The warmer the molding compound is, the faster the molecules in the thermoplastic move and the more liquid the thermoplastic becomes, so that slow introduction at low pressure leads to good filling of the mold cavity. Both the molecules in the thermoplastic and any fibers present are spared from damage or orientation, thereby permitting a finished dental molding of extremely high strength to be obtained.

In a preferred embodiment, the molding compound is thermally regulated or homogenized prior to introduction of the thermoplastic, so that approximately the same temperature is present in all areas. This brings advantages for the pressing of a plurality of objects, for example a plurality of crowns or bridges.

The inventive method fundamentally does not necessitate any reinforcement of the molding compound.

However, it is of course possible to use such reinforcement, for example in the form of a metal enclosure surrounding the molding compound.

The inventive method makes it possible to avoid high pressures during introduction of the thermoplastic into the mold cavity. For example, weights of approx. 2 kilograms to 5 kilograms which are applied to the pressing plunger already suffice for homogeneous introduction. This makes it possible to realize advantageous apparatuses.

Hereinafter the invention will be explained in more detail by way of example with reference to the enclosed drawing. Therein are shown:

FIGS. 1 and 2 blanks made of a thermoplastic;

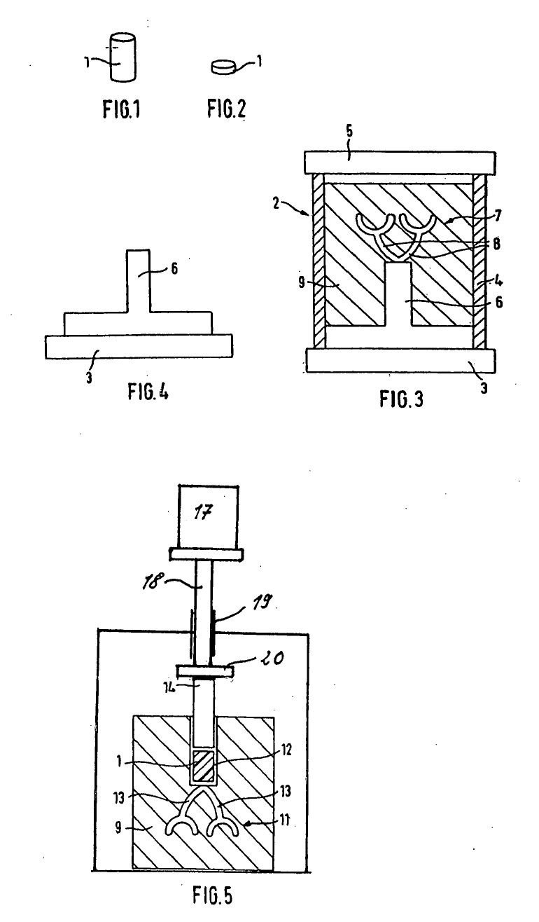

FIG. 3 a section through a muffle;

FIG. 4 a view of the muffle base of the muffle according to FIG. 3;

FIG. 5 a section through the cured molding compound with the pressing apparatus;

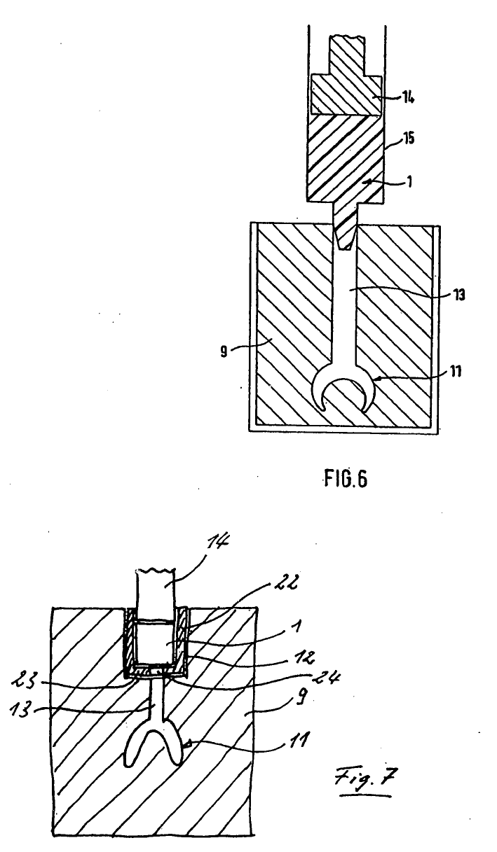

FIGS. 6 and 7 sections through the cured molding compound according to other embodiments.

According to FIG. 1, the blank 1 formed from a thermoplastic has a cylindrical form possessing a height greater than its diameter. According to FIG. 2, the blank 1 is instead configured to be disk-shaped.

According to FIG. 3, a muffle 2 consists of a muffle base 3, a muffle wall or sleeve 4 and a muffle cover 5.

The muffle base 3 has in the middle a projection 6 having a diameter corresponding to the blank 1.

Above the projection 6 there is disposed according to FIG. 3 a wax model 7 of the dental molding to be produced, e.g. two crown copings. The wax model 7 is connected to the projection 6 with wax rods 8 or the like. The muffle 2 is filled with a temperature-resistant curable molding compound 9.

The molding compound 9 is subsequently cured in the muffle 2. Thereafter the cover 5, the muffle wall 4 and the muffle base 3 are removed.

The wax model 7 including the wax rods 8 is then melted. Thus there is formed in the molding compound 9 a mold cavity 11 corresponding to the negative of the dental molding to be produced, further a prepressing space 12 corresponding to the projection 6, as well as feeding channels 13 connecting the mold cavity 11 to the prepressing space 12 (FIG. 5).

The prepressing space 12 is filled with a blank 1 and the blank 1 subjected to pressure by a plunger 14 to press the thermoplastic through the channels 13 into the mold cavity 11.

The pressing plunger 14 consists of the same molding compound as the molding compound 9, at least in its front area. The back area of the plunger 14 can for example also consist of ceramics. The plunger 14 is subjected to a weight 17 disposed on a pusher 18 which is guided with a guide means 19 and rests with a stop face 20 on the plunger 14.

The thermoplastic blank 1 has been preheated by a heating device (not shown) to a processing temperature of for example 300° C. At the same time the molding compound 9 is heated by a heating device (not shown) for example to a temperature of 330° C. After the thermoplastic 1 has been pressed into the mold cavity 11 the molding compound 9 is cooled and after solidification of the thermoplastic in the mold cavity 11 the dental molding is released by the gates formed by the channels 11.

The embodiment according to FIG. 6 differs from that according to FIG. 5 substantially in that, instead of the prepressing space 12 for receiving the blank, a feeding funnel 15 is provided which receives the thermoplastic melt formed from the blank 1 to supply it to the mold cavity 11 through the connecting channel 13. The feeding funnel 15 has the pressing plunger 14 guided therein.

In the embodiment according to FIG. 7, the blank 1 is disposed in a sheath 22, e.g. made of metal or ceramics. The sheath 22 with the blank 1 can be preheated independently of the molding compound 9 e.g. in an oven. The sheath 22 has an outside diameter corresponding to the outside diameter of the prepressing space 12 in the molding compound 9. The inside diameter of the sheath 22 corresponds to the outside diameter of the plunger 14. The sheath 22 has a bottom 23 with a passage 24 which is flush with the feeding channel 13.

1. A method for producing dental moldings from a thermoplastic, wherein
a shaping model (7) of the desired dental molding is produced from wax, plastic or a similar fusible, combustible or otherwise residue-free removable material,
the shaping model (7) is embedded in a heat-resistant molding compound (9), the model (7) having a connection to the outer side of the molding compound (9) directly or at least with a connecting element (8) of wax, plastic or a similar fusible, combustible or otherwise residue-free removable material,
the molding compound (9) is cured and the model (7) and the optionally present at least one connecting element (8) are removed from the molding compound (9), preferably by the action of heat, to form a mold cavity (11) corresponding to the negative of the desired dental molding,
the thermoplastic heated to processing temperature is introduced under pressure into the formed mold cavity (11) in the molding compound (9) through the connection to the outer side, and
the thermoplastic forming the desired dental molding is released after solidification,
characterized in that the molding compound (9) has a temperature of at least 150° C. in the area of the mold cavity (11) at the time of introduction of the thermoplastic.

2. The method according to claim 1, characterized in that the temperature of the molding compound (9) in the area of the mold cavity (11) is no less than 100° C. below the processing temperature of the thermoplastic.

3. The method according to claim 2, characterized in that the temperature of the molding compound (9) at the time of introduction of the thermoplastic corresponds at least to the processing temperature of the thermoplastic.

4. The method according to claim 1, characterized in that the shaping model (7) of the dental molding is produced by a generative manufacturing method.

5. The method according to claim 1, characterized in that the thermoplastic used for the dental molding is a semi-crystalline thermoplastic.

6. The method according to claim 1, characterized in that the thermoplastic used for the dental molding is an aromatic thermoplastic.

7. The method according to claim 6, characterized in that the aromatic thermoplastic used is a polyarylate, a polyarylene sulfide, a polysulfone, a liquid crystal polymer, a polyimide, a polyetherimide, a polyamidimide or a polyaryletherketone, or a copolymer of at least two of said polymers or a blend of at least two of said polymers.

8. The method according to claim 7, characterized in that the polyaryletherketone(PAEK) used is a polyetherketone (PEK), a polyetheretherketone (PEEK), a polyetherketoneketone (PEKK), a polyetheretherketoneketone (PEEKK), a polyetherketoneetherketoneketone (PEKEKK) or a copolymer of at least two of said polymers or a blend of at least two of said polymers.

9. The method according to claim 1, characterized in that the thermoplastic contains fillers.

10. The method according to claim 9, characterized in that the thermoplastic contains reinforcing fibers and/or color additives as fillers.

11. The method according to claim 9 characterized in that the thermoplastic contains fillers of altogether more than 10 wt %, preferably more than 30 wt %.

12. The method according to claim 10, characterized in that the content of reinforcing fibers is at least 25 wt %, preferably at least 30 wt %.

13. The method according to claim 10, characterized in that the content of reinforcing fibers is at least 30 vol %, preferably at least 40 vol %.

14. The method according to claim 1, characterized in that the filling of the mold cavity (11) by introduction of the thermoplastic into the molding compound (9) lasts longer than 1 second, preferably lasting longer than 3 seconds.

15. The method according to claim 1, characterized in that the thermoplastic is introduced into the mold cavity (11) of the molding compound by an injection molding method, transfer molding method, compression molding method, injection method or extrusion method.

16. The method according to claim 1, characterized in that the cooling of the thermoplastic dental molding is effected in the molding compound (9) under pressure.

17. The method according to claim 1, characterized in that the thermoplastic dental molding is cooled at a speed of less than 20° C./min, in particular less than 10° C./min.

18. The method according to claim 1, characterized in that a predried thermoplastic is used.

19. The method according to claim 18, characterized in that a predried thermoplastic is made available for processing in vacuum packed form.

20. The method according to claim 1, characterized in that a thermoplastic in the form of a prefabricated blank (1) is used.

21. The method according to claim 20, characterized in that the blank (1) has a greater height than width.

22. The method according to claim 1, characterized in that a prepressing space (12) is provided in the molding compound (9) for receiving the thermoplastic.

23. The method according to claim 22, characterized in that the heating of the thermoplastic is effected up to the processing temperature in the prepressing space (12).

24. The method according to claim 20, characterized in that the blank (1) has a cross section and/or an outside diameter which corresponds substantially to the cross section and/or the inside diameter of the prepressing space (12).

25. The method according to claim 1, characterized in that the pressure is exerted on the thermoplastic by a plunger (14) which has a cross section and/or an outside diameter which corresponds substantially to the cross section and/or the inside diameter of the prepressing space (12).

26. The method according to claim 25, characterized in that the plunger (14) is heated before introduction of the thermoplastic.

27. The method according to claim 1, characterized in that the temperature of the plunger (14) upon introduction of the thermoplastic corresponds to the temperature of the molding compound (9) or is thereabove.

28. An apparatus for carrying out the method according to claim 1, characterized by a device for applying pressure to the plunger (14) for introducing the thermoplastic into the mold cavity (11) of the molding compound (9).

29. A thermoplastic blank (1) for use according to claim 1.

30. A dental molding obtained according to claim 1.

31. The dental molding according to claim 30, characterized in that it is a removable and/or fixed dental prosthesis or a combination of removable and fixed dental prosthesis.
